(19) United States
(12) Patent Application Publication
(10) Pub. No.: US 2015/0067356 A1
(43) Pub. Date: Mar. 5, 2015

(54) POWER MANAGER FOR MULTI-THREADED DATA PROCESSOR

(71) Applicant: Advanced Micro Devices, Inc., Sunnyvale, CA (US)

(72) Inventors: Vignesh Trichy Ravi, Austin, TX (US); Manish Arora, Dublin, CA (US); William Brantley, Austin, TX (US); Srilatha Manne, Portland, OR (US); Indrani Paul, Round Rock, TX (US); Michael Schulte, Austin, TX (US)

(73) Assignee: Advanced Micro Devices, Inc., Sunnyvale, CA (US)

(21) Appl. No.: 14/015,369

(22) Filed: Aug. 30, 2013

(51) Int. Cl. G06F 1/26

(52) U.S. Cl. CPC G06F 1/26
USPC 713/300

(57) ABSTRACT

A data processing system includes a plurality of processor resources, a manager, and a power distributor. Each of the plurality of data processor cores is operable at a selected one of a plurality of performance states. The manager assigns each of a plurality of program elements to one of the plurality of processor resources, and synchronizing the program elements using barriers. The power distributor is coupled to the manager and to the plurality of processor resources, and assigns a performance state to each of the plurality of processor resources within an overall power budget, and in response to detecting that a program element assigned to a first processor resource is at a barrier, increases the performance state of a second processor resource that is not at the barrier within the overall power budget.

### FIELD

This disclosure relates generally to data processors, and more specifically to power management for multi-threaded data processors.

### BACKGROUND

Modern microprocessors for computer systems include multiple central processing unit (CPU) cores and run programs under operating systems such as Windows, Linux, the Macintosh operating system, and the like. An operating system designed for multi-core microprocessors typically distributes processing tasks by assigning different threads or processes to different CPU cores. Thus a large number of threads and processes can concurrently co-exist in multi-core microprocessors.

However there is a need for the threads and processes to synchronize and sometimes communicate with each other to perform the overall task of the application. When a CPU core reaches a synchronization or communication point, known as a barrier, it waits until another one or more threads reach a corresponding barrier. While a CPU core is waiting at a barrier, it performs no useful work.

If all concurrent threads and processes reached their barriers at the same time, then no thread would be required to wait for another and all threads could proceed with the next operation. This ideal situation is rarely encountered and the typical situation is that some threads wait for other threads at barriers, and program execution is imbalanced. There are several reasons for the imbalance, including different computational power among CPU cores, imbalances in the software design of the threads, variations of the runtime environments between the CPU cores, hardware variations, and an inherent imbalance between the starting states of the CPU cores. The result of this performance imbalance is to limit the speed of execution of the application program while some threads idle and wait at barriers for other threads.

### BRIEF DESCRIPTION OF THE DRAWINGS

FIG. 1 illustrates in block diagram form a data processing system according to some embodiments.

FIG. 2 illustrates in block diagram form a portion of a multi-threaded operating system.

FIG. 3 illustrates a block diagram of a runtime system component, such as the cluster manager or the node manager of FIG. 1.

FIG. 4 illustrates a flow diagram of a method for use with a multi-threaded operating system according to some embodiments.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION OF ILLUSTRATIVE EMBODIMENTS

A data processing system as described herein is a multi-threaded, multi-processor system that allows power to be distributed among processor resources such as APUs or CPU cores by observing whether processing resources are waiting at a barrier, and if so re-allocating power credits between those processing resources and other, still-active processing resources, thereby allowing the other processing resources to complete their tasks in a shorter period of time and improving performance. As used herein, a power credit is a unit of power that is a fraction of a total power budget that may be allocated to a resource such as a CPU core for a period of time.

In one form, such a data processing system includes processor cores each operable at a selected one of a plurality of performance states, a thread manager for assigning program threads to respective processor cores, and synchronizing program threads using barriers, and a power distributor coupled to the thread manager and to the processor cores, for assigning a performance state to each of the plurality of processor cores within an overall power budget, and in response to detecting that a program thread assigned to a first processor core is at a barrier, decreasing the performance state of the first processor core and increasing the performance state of a second processor core that is not at a barrier while remaining within the overall power budget.

In another form, a data processing system includes a cluster manager and a set of node manager corresponding to each of a plurality of processor nodes. Each node includes a plurality of processor cores, each operable at a plurality of performance states. The cluster manager assigns a node power budget to each node. Each node has a corresponding node manager. Each node manager includes a thread manager and a power distributor. The thread manager assigns program threads to respective ones of the plurality of processor cores, and synchronizes the program threads using barriers. The power distributor is coupled to the thread manager and to the processor cores, and assigns a performance state to each of the plurality of processor cores within a corresponding node power budget, and in response to detecting that a program thread assigned to a first processor core is at a barrier, decreasing the performance state of the first processor core and increasing the performance state of a second processor core that is not at a barrier within the node power budget.

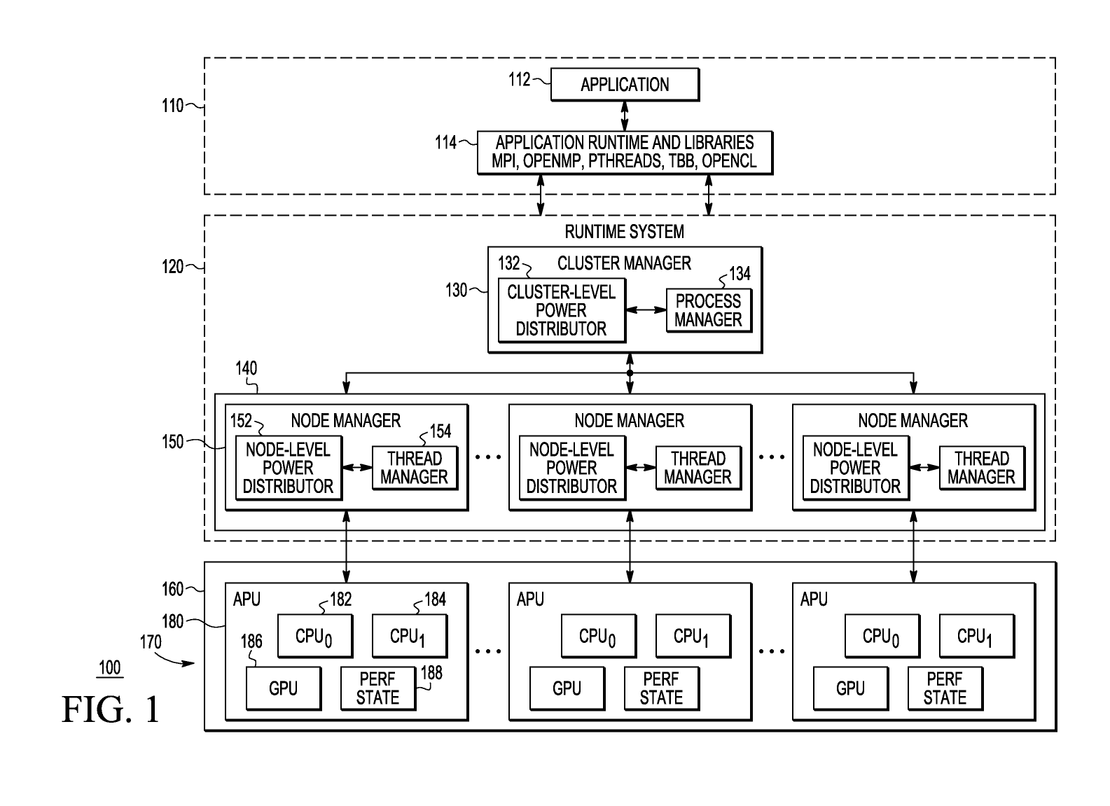

FIG. 1 illustrates in block diagram form a data processing system 100 according to some embodiments. Data processing system 100 includes both hardware and software components arranged in a hierarchy, including an application layer 110, a runtime system 120, and a platform layer 160.

Application layer 110 is responsive to any of a set of application programs 112 that interface to lower system layers through an application programming interface (API) 114. API 114 includes application and runtime libraries such as the Message Passing Interface (MPI) developed by MPI Working Group, the Open Multi-Processing (OpenMP) interface developed by the OpenMP Architecture Review Board, the Pthreads standard for creating and manipulating threads (IEEE Std 1003.1c-1995), Thread Building Blocks (TBB) defined by the Intel Corporation, the Open Computing Language (OpenCL) developed by the Khronos Group, and the like.

Runtime system 120 includes generally a cluster manager 130 and a set of node managers 140. Cluster manager 130 is used for overall system coordination and is responsible for maintaining the details of the processes involved in all nodes in the cluster. Cluster manager 130 includes a process manager 134 that assigns processes to each of the nodes, and a cluster level power distributor 132 that coordinates with process manager 134 to distribute power credits to each node. A node manager is assigned to each node in the cluster such that an instance of the node manager is running on each node. Each node manager such as representative node manager 150 includes a thread manager 154 that manages the thread distribution within the node, and a node-level power distributor 152 that is responsible for determining the power budget for its node based on the number of CPU cores within the node. Cluster manager 130 and node managers 140 communicate initially to exchange power budget information, and then periodically exchange information at every budget change, e.g. when a thread reaches a barrier as will be described further below.

Platform layer 160 includes a set of processor resources for execution of the application programs. In one form, platform layer 160 includes a set of nodes 170 including a representative node 180. The interfaces in application layer 110 and runtime system 120 are designed to operate on a variety of hardware platforms and with a variety of processor resources. In the example of FIG. 1, a representative node 180 is an accelerated programming unit (APU) that includes two CPU cores 182 and 184 labeled “CPU₀” and “CPU₁”, respectively, a graphics processing unit (GPU) core 186, and a set of performance state registers 188. It should be apparent that the number of CPU and GPU cores within each node may vary between embodiments. Each node could be an APU with both one or more CPUs and one or more GPUs as shown, a multi-core processor with multiple CPU cores, a many-core processor with discrete GPUs, etc. In an APU system as shown in FIG. 1, the most widely adopted execution model contains a process running on each node. Within each node, the process spawns a number of light-weight threads to exploit the available cores within the node. This platform model maps to popular programming models like MPI+Pthreads, MPI+OpenMP, MPI+OpenCL, etc.

A data processing system using runtime system 120 is able to handle power credit re-allocation automatically in hardware and software and does not require source code changes for legacy application programs. Moreover it improves the performance of applications that use barriers for process and/or thread synchronization within a given power budget. In some cases, it provides the opportunity to improve performance and save power at the same time, since processes and threads complete faster and don't require resources such as CPU cores to consume power while idling.

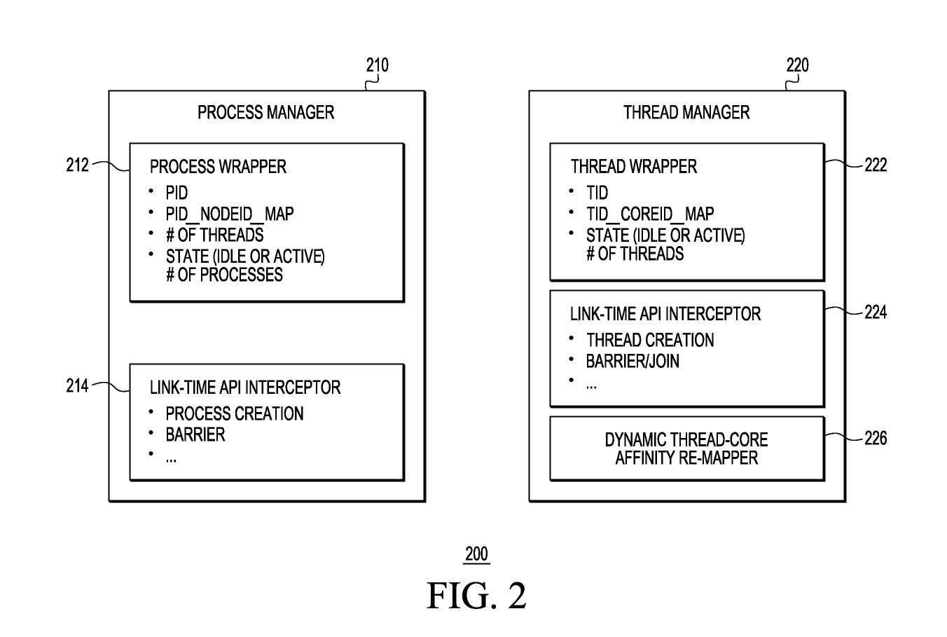

FIG. 2 illustrates in block diagram form a portion of a multi-threaded operating system 200 according to some embodiments. Multi-threaded operating system 200 generally includes a process manager 210 and a thread manager 220 that correspond to process manager 134 and thread manager 154, respectively, of FIG. 1. Process manager 210 and a thread manager 220 contain data structures and interfaces that form the building blocks for the cluster-level and node-level power redistribution policies of data processing system 100.

Process manager 210 includes a process wrapper 212 and a link-time API interceptor 214. Process wrapper 212 is a descriptor for each process existing in the system and includes a process identifier labeled “PID”, a map between the PID and the node labeled “PID_NodeID_Map”, a number of threads associated with the process labeled “# of Threads”, and a state descriptor, either Idle or Active, labeled “State”. These elements of process wrapper 212 are duplicated for each process in the system. Link-time API interceptor 214 is a software module that includes elements such as a process creation component module, a barrier handler, and the like. The process creation module creates a library similar to MPI, Pthreads, etc. and imitates the signature of the original library. This duplicate library in turn links to and calls the APIs from the original library. This capability allows applications running in this environment to avoid the need for source code changes, simplifying the task of programmers. The barrier handler facilitates communication between different processes waiting at a barrier.

Thread manager 220 includes components similar to process manager 210, including a thread wrapper 222, a link-time API interceptor 224, and an additional dynamic thread-core affinity remapper 226. Thread wrapper 222 is a descriptor for each thread assigned to a corresponding node and includes a thread identifier labeled “TID”, a map between the TID and the specific core the thread is assigned to labeled “TID_CoreID_Map”, and a state descriptor, either Idle or Active, labeled “State”. These elements of thread wrapper 222 are duplicated for each thread assigned to the corresponding node. Link-time API interceptor 224 includes elements such as a thread creation component module that creates a library similar to MPI, Pthreads, etc. and imitates the signature of the original library. This duplicate library in turn links to and calls the APIs from the original library. This capability allows applications running in this environment to avoid the need for source code changes, simplifying the task of programmers. Thread manager 220 also includes a dynamic thread-core affinity remapper 226, which uses processor affinity APIs provided by the operating system libraries to migrate a thread from one core to another. Thus when the number of threads is greater than the number of cores, idle threads can be fragmented onto different cores. By defragmenting such idle threads, thread manager 220 is able to better utilize the available cores and thus power credits.

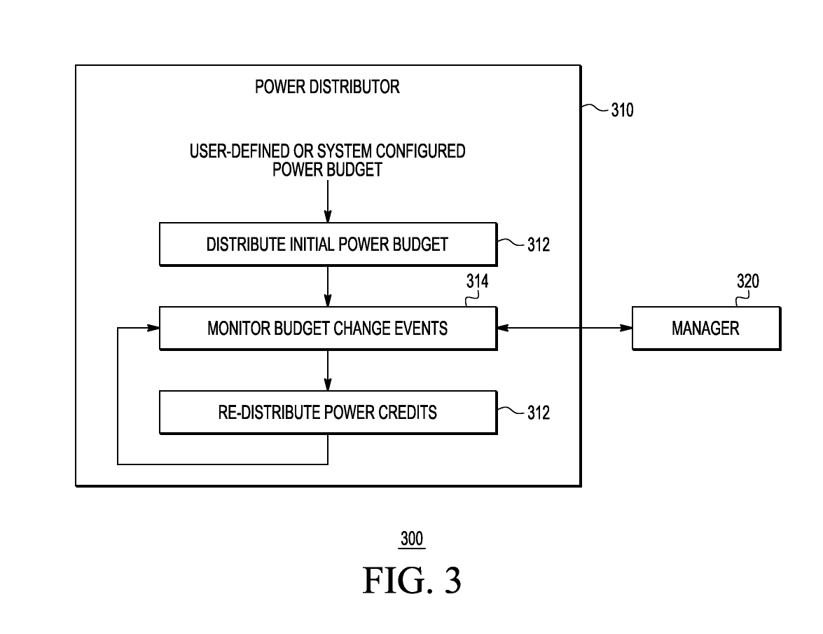

FIG. 3 illustrates a block diagram of a runtime system component 300, such as cluster manager 130 or node manager 140 of FIG. 1. If runtime system component 300 is a cluster manager 130, it manages all the nodes in the cluster, whereas if runtime system component 300 is a node manager 140, it manages all the cores in the node.

Runtime system component 300 includes generally a power distributor 310 and a manager 320. Power distributer 310 is responsive to a user-defined or system-configured power budget to perform a distribution process which begins with a step 312 which distributes an initial power budget for each node in the cluster (if runtime system component 300 is a cluster manager) or for each core in the node (if runtime system component 300 is a node manager). Subsequently as the application starts and continues to run on the platform resources, power distributor 310 goes into a loop which starts with a step 314 that, responsive to inputs from a manager 320, monitors budget change events. These events include the termination or idling of a thread or process and a thread or process reaching a barrier. In response to such a budget change event, power distributor 310 proceeds to step 316, in which it re-distributes power credits. For example when manager 320 signals that a thread is at a barrier, it claims power credits from the corresponding processor and re-distributes the power credits to one or more active processors. By doing so, an active processor reaches its barrier faster and resolution of the barrier occurs sooner, resulting in better performance. After redistributing the power credits, power distributor 310 returns to step 314 and waits for subsequent budget change events.

Thus manager 320 identifies the processes/threads waiting at a barrier. These idle resources may be placed in the lowest P-state, a lower C-state, or even power gated. As they become idle, there may be some other processes/threads that are still actively executing. Manager 320 reallocates power credits from the resources associated with the idle processes/threads, and transfers them to the active processes/threads to allow them to reach the barrier faster. For example, manager 320 can take the aggregate available power credits from idle resources and re-distribute them evenly across the remaining, active resources. When additional threads/processes reach the barrier, manager 320 performs this re-allocation iteratively until all the process/threads reach the barrier. After that, the power credits are reclaimed and returned back to their original owners. Manager 320 boosts the active processes/threads consistent with the power and thermal limits allowed by the resource. In some embodiments, boosted threads can temporarily utilize non-sustainable performance states such as hardware P0 or boosted P0 states, instead of just being limited to sustainable power states such as software P0 states, as long as the total power is within the overall node power budget.

For example, a simple multi-threaded system may assign only one process (thread) to each node (core). In essence, there is one-to-one mapping. In this case, as the processes/threads become idle their nodes/cores can be put in low power states in order to boost the frequency of the nodes/cores that correspond to active processes/threads.

Power allocation can become much more complicated if there is a many-to-one mapping between the processes/threads to nodes/cores. For example, if there are two threads mapped to a core, then it is possible that one thread may be active and the other thread idle at a barrier. In such a case, idle threads could be fragmented across different cores, leading to poor utilization of the power budget. Such a situation can be handled in the following way. First, the runtime system could identify an opportunity for defragmenting such idle threads across different cores. It could group them in such a way that all idle threads are mapped to a single core, and the active threads get evenly distributed across the remaining cores. This way the active threads and corresponding cores will be able to borrow maximum power credits and boost their performance to reach the barrier faster. Later during power credit reclamation, the idle threads would be remapped to their original cores as they become active. One downside to this approach is added overhead due to migration, such as additional cache misses as the runtime system moves threads to other cores; however, this overhead can be mitigated by deeper cache hierarchies.

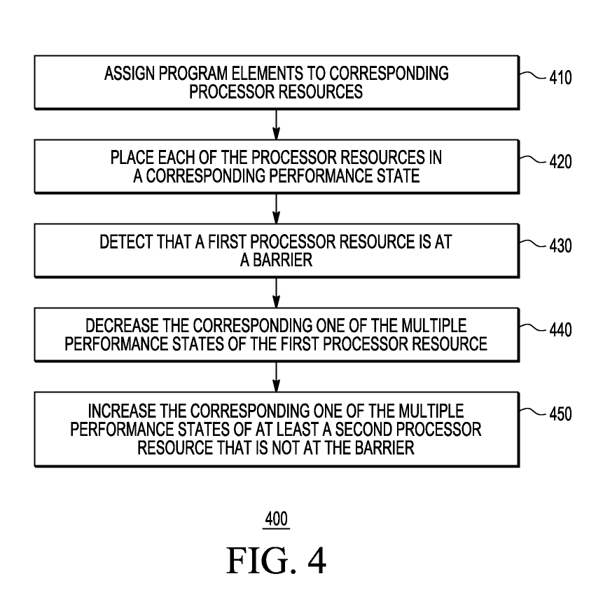

FIG. 4 illustrates a flow diagram of a method 400 for use with a multi-threaded operating system according to some embodiments. In step 410, thread manager 154 assigns multiple program threads to corresponding ones of multiple processor cores in platform layer 160. For example, thread manager 154 assigns a first program thread to CPU core 182, and a second program thread to CPU core 184. At step 420, node-level power distributor 182 places each of the multiple processor cores in a corresponding one of multiple performance states. For example, CPU cores 182 and 184 may have a set of six performance states, designated P0-P6, in which P0 corresponds to the highest performance level and P6 to the lowest performance level. Each performance state has an associated clock frequency and an associated power supply voltage level that ensures proper operation at the corresponding clock frequency. Thread manager 154 may place both CPU core 182 and CPU core 184 initially into the P2 state if node-level power distributor 152 determines these are the highest power states with its assigned power budget, and both CPU cores start executing their assigned program threads.

Next at step 430, thread manager 154 detects that a first processor core is at a barrier. For example, assume CPU core 182 encounters a barrier. Thread manager 154 detects this condition and signals node-level power distributor 152, which is monitoring budget change events, that CPU core 182 has encountered a barrier. In response, node-level power distributor 152 re-distributes power credits between CPU core 182 and CPU core 184. It does this by decreasing the corresponding one of the multiple performance states of the first processor core in step 440, and increasing the corresponding one of the plurality of performance states of a second processor core, e.g. CPU core 184, that is not at the barrier in step 450. For one example, node-level power distributor 152 places CPU core 182, which is waiting at a barrier, into the P6 state while placing CPU core 184, which has not yet encountered the barrier, into the P0 state. Thus CPU core 184 is now able to get to its barrier faster. When CPU core 184 eventually reaches the barrier also, runtime system 120 synchronizes the cores, and resumes operation by again placing both CPU cores in the P2 state.

As shown in FIG. 4, this method can be extended to systems with more than two cores. In step 440, node-level power distributor 152 determines a residual power credit as the difference between the power credit and an incremental power consumption of the second core at its increased performance state. This residual power credit is then available to increase the performance state of a further CPU core, and in step 450, node-level power distributor 152 increases a performance state of a third processor core that is not at a barrier based on the residual power credit. The process is repeated until all power credits are redistributed and the barrier is resolved.

In other embodiments, a data processing system could be responsive to the progress of threads toward reaching a barrier. A node manager can monitor the progress of threads toward a common barrier, for example by checking the progress at certain intervals. If one thread is significantly ahead of other threads, the node manager can reallocate the power credits between the threads and the CPU cores running the threads to reduce the variability in completion times.

Although in the illustrated embodiment application layer 110 and runtime system 120 are software components and platform layer 160 is a hardware component, these three layers may be implemented with various combinations of hardware and software, such as with embedded microcontrollers. Some of the software components may be stored in a computer readable storage medium for execution by at least one processor. Moreover the method illustrated in FIG. 4 may also be governed by instructions that are stored in a computer readable storage medium and that are executed by at least one processor. Each of the operations shown in FIG. 4 may correspond to instructions stored in a non-transitory computer memory or computer readable storage medium. In various embodiments, the non-transitory computer readable storage medium includes a magnetic or optical disk storage device, solid-state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

Moreover, any one or multiple ones of the processor cores in platform layer 160 of FIG. 1 may be described or represented by a computer accessible data structure in the form of a database or other data structure which can be read by a program and used, directly or indirectly, to fabricate integrated circuits. For example, this data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates that also represent the functionality of the hardware comprising integrated circuits. The netlist may then be placed and routed to produce a data set describing geometric shapes to be applied to masks. The masks may then be used in various semiconductor fabrication steps to produce the integrated circuits. Alternatively, the database on the computer accessible storage medium may be the netlist (with or without the synthesis library) or the data set, as desired, or Graphic Data System (GDS) II data.

While particular embodiments have been described, various modifications to these embodiments will be apparent to those skilled in the art. In the illustrated embodiment, each node included two CPU cores and one GPU core. In other embodiments, each node could include more processor cores. Moreover the composition of the processor cores could vary in other embodiments. For example, instead of including two CPU and one GPU core, a node could include eight CPU cores. In another example, a node may comprise multiple die stacks of CPU, GPU, and memory. Moreover, more variables besides clock frequency and power supply voltage could define a performance state, such as whether dynamic power gating is enabled.

Accordingly, it is intended by the appended claims to cover all modifications of the disclosed embodiments that fall within the scope of the disclosed embodiments.

What is claimed is:

1. A data processing system comprising:
a plurality of processor resources each operable at a selected one of a plurality of performance states;
a manager for assigning each of a plurality of program elements to one of said plurality of processor resources, and synchronizing said program elements using barriers; and
a power distributor coupled to said manager and to said plurality of processor resources, for assigning a performance state to each of said plurality of processor resources within an overall power budget, and in response to detecting that a program element assigned to a first processor resource is at a barrier, increasing said performance state of a second processor resource that is not at said barrier within said overall power budget.

2. The data processing system of claim 1, wherein said plurality of program elements comprise a plurality of threads, said plurality of processor resources comprises a plurality of processor cores, and said performance state comprises an operating voltage and an operating frequency.

3. The data processing system of claim 2, wherein said plurality of processor cores comprise at least one central processing unit (CPU) core and at least one graphics processing unit (GPU) core.

4. The data processing system of claim 2, wherein said manager is a node manager comprising:
a thread manager, for assigning a plurality of program threads to one of said plurality of processor cores, and synchronizing said program threads using barriers; and
a node-level power distributor coupled to said thread manager and to said processor cores, for assigning a performance state to each of said plurality of processor cores within a corresponding node power budget, and in response to detecting that a program thread assigned to a first processor core is at a barrier, decreasing said performance state of said first processor core and increasing said performance state of a second processor core that is not at said barrier within said node power budget.

5. The data processing system of claim 4, wherein said node-level power distributor, in response to detecting that a program thread assigned to a first processor core is at a barrier, decreases said performance state of said first processor core.

6. The data processing system of claim 4, wherein said thread manager comprises:
a plurality of thread wrappers for each thread including a state descriptor that indicates whether a corresponding thread is active or idle; and
a link-time application programming interface (API) interceptor comprising a barrier handler for facilitating communication between different threads waiting at a barrier.

7. The data processing system of claim 6, wherein said thread manager further comprises:
a remapper for defragmenting idle threads across said plurality of processor cores.

8. The data processing system of claim 1, wherein said plurality of program elements comprise a plurality of processes, said plurality of processor resources comprises a plurality of processor nodes, and said performance state comprises a node power budget.

9. The data processing system of claim 8, wherein said manager is a cluster manager comprising:
a process manager for assigning processes among said plurality of nodes; and
a cluster-level power distributor coupled to said process manager, for assigning initial power credits to each of said plurality of processor nodes, and re-distributing said power credits among active nodes in response to a process encountering a barrier.

10. The data processing system of claim 9, wherein said process manager comprises:
a plurality of process wrappers for each process including a state descriptor that indicates whether a corresponding process is active or idle; and
a link-time application programming interface (API) interceptor comprising a barrier handler for facilitating communication between different processes waiting at a barrier.

11. The data processing system of claim 1, wherein said power distributor, in response to detecting that said program element assigned to said first processor resource is at said barrier, decreases said performance state of said first processor resource.

12. A data processing system comprising:
a cluster manager, for assigning a node power budget for each of a plurality of nodes; and
a corresponding plurality of node managers, each comprising:
a thread manager, for assigning a plurality of program threads to one of a plurality of processor cores, and synchronizing said program threads using barriers; and
a node-level power distributor coupled to said thread manager and to said processor cores, for assigning a performance state to each of said plurality of processor cores within a corresponding node power budget, and in response to detecting that a program thread assigned to a first processor core is at a barrier, increasing said performance state of a second processor core that is not at said barrier within said node power budget.

13. The data processing system of claim 12, wherein said performance state of each of said plurality of processor cores is defined by at least an operating voltage and a frequency.

14. The data processing system of claim 12, wherein said cluster manager comprises:
a process manager for assigning processes among said plurality of nodes; and
a cluster-level power distributor coupled to said process manager and to each of said plurality of node managers, for assigning initial power credits to each of said plurality of node managers, and re-distributing said power credits among active nodes in response to a process encountering a barrier.

15. The data processing system of claim 14, wherein said process manager comprises:
a plurality of process wrappers for each process including a state descriptor that indicates whether a corresponding process is active or idle; and
a link-time application programming interface (API) interceptor comprising a barrier handler for facilitating communication between different processes waiting at a barrier.

16. The data processing system of claim 12, wherein said thread manager comprises:
a plurality of thread wrappers for each thread including a state descriptor that indicates whether a corresponding thread is active or idle; and
a link-time application programming interface (API) interceptor comprising a barrier handler for facilitating communication between different threads waiting at a barrier.

17. The data processing system of claim 16, wherein said thread manager further comprises:
a remapper for migrating at least one of said program threads from one of said plurality of nodes to another of said plurality of nodes.

18. The data processing system of claim 12 having an input adapted to receive requests from an application layer.

19. The data processing system of claim 12, wherein said node-level power distributor, in response to detecting that said program thread assigned to said first processor core is at said barrier, decreases said performance state of said first processor core.

20. A method comprising:
assigning a plurality of program elements to corresponding ones of a plurality of processor resources;
placing each of said plurality of processor resources in a corresponding one of a plurality of performance states;
detecting that a first processor resource is at a barrier; and
increasing said corresponding one of said plurality of performance states of a second processor resource that is not at said barrier.

21. The method of claim 20 wherein said increasing comprises:
increasing corresponding ones of said plurality of performance states of said plurality of processor resources that are not at said barrier including said second processor resource.

22. The method of claim 21 wherein said assigning comprises:
assigning a plurality of threads to corresponding ones of a plurality of processor cores.

23. The method of claim 21 wherein said assigning comprises:
assigning a plurality of processes to corresponding ones of a plurality of processor nodes.

24. The method of claim 20 further comprising:
decreasing said corresponding one of said plurality of performance states of said first processor resource in response to detecting that said first processor resource is at said barrier.
